(19) United States
(12) Patent Application Publication
(10) Pub. No.: US 2005/0187833 A1
(43) Pub. Date: Aug. 25, 2005

(54) Automated equipment management and reservation system

(75) Inventors: Bruce Royer, Cave Creek, AZ (US); Renee Royer, Cave Creek, AZ (US); John Taylor, Scottsdale, AZ (US)

Correspondence Address: TIFFANY & BOSCO, 2525 East Camelback Road, Phoenix, AZ, 85016-4237, US

(73) Assignee: U-Haul International, Inc.

(21) Appl. No.: 09/826,083

(22) Filed: Apr. 4, 2001

(51) Int. Cl. G06F 17/60

(52) U.S. Cl. 705/28

(57) ABSTRACT

The present invention provides an automated equipment management and reservation system that includes access to tools, information, and aids for managing an equipment rental business that is involved in in-town and one-way rentals. In a preferred embodiment of the invention, the system provides the user with reservation information in several different formats. The user can change the scope of the reservation information to display reservations for a particular location, or for specific equipment at that location. If a location does not have enough equipment to cover reservations, the system allows the user to search nearby locations for the needed equipment. The system tracks the equipment inventory at each location and automatically updates the inventory when equipment is dispatched to another location or received from another location. To facilitate communication between rental locations, the system provides a means for transmitting reservation information and messages pertaining to specific reservations.

### FIELD OF THE INVENTION

The present invention relates generally to an automated equipment management and reservation system and, more particularly to an automated system to manage reservations, inventory rental equipment, track the movement and status of the rental equipment, and confirm the availability of equipment for every reservation.

### BACKGROUND OF THE INVENTION

The equipment rental business, particularly rental of moving equipment, is a dynamic business wherein hundreds of reservations are made in a day and the inventory is constantly moving from one location to another. To facilitate the management of the rental equipment business, the rental locations are organized by marketing companies. A marketing company, as used herein, refers to a cluster of equipment rental locations that are geographically within the same region of the country. The marketing company keeps track of the inventory of each location, the reservations for each location, and confirmation that there is sufficient equipment to fulfill the reservations for each particular location.

A customer's first contact with the rental equipment company is generally a telephone call to a customer service representative to inquire about the type of equipment available and the rental price. Upon receiving the reservation, the reservation location must ensure that the reservation is covered. “Covered” is used herein to refer to the process of confirming that the pick-up location has the equipment that is needed to fulfill the reservation. To cover the reservation, one must have knowledge of the inventory of the pick-up location. If the pick-up location does not have the equipment, then it is necessary to look to nearby locations for the particular equipment. Accordingly, one must have knowledge of the inventory of the nearby locations, as well. It is difficult to accurately keep track of the inventory at each location because equipment is constantly rented and moved from one location to another.

In known inventory tracking systems, the marketing company tracks the inventory of equipment at each location and the movement of equipment from one location to another. The marketing company's known tracking system includes a white board that is updated with each reservation. This system has numerous disadvantages. First, the known tracking system is not accessible to all locations. Only employees in the marketing company are able to view the information on the white board. Second, the known tracking system does not update automatically; someone has to make every entry on the white board and verify that the information has been accurately recorded. Accordingly, to facilitate the processing of covering the rented equipment, there is a need for a system that provides updated information to all locations within a marketing company and updates regularly and automatically.

When assisting a customer with a reservation, it is not unusual for a customer to have a specific request or a special requirement that needs to be communicated to the pick-up location. Accordingly, there is a need for a system that provides a convenient tool for recording a customer's special request that can be viewed by the reservation location and the pick-up location. Additionally, during the course of a transaction, the customer may call back several times to make changes to a reservation. To avoid explaining the history of a transaction to a customer service representative that is not familiar with the reservation, the customer must be able to contact the same representative that took the original reservation. If the original representative is not available, the customer must repeat the history of the transaction. For a more efficient and satisfactory system, there is a need to provide a convenient tool for recording the history of a reservation so that all customer service representative know the history of a transaction.

To ensure that all reservations are covered, it is desirable to print out various reports pertaining to the reservations, the equipment, or both. If a specific pick-up location is contemplated, it desirable to be able to generate a report pertaining specifically to the contemplated location. Similarly, if a particular equipment is of interest, it is desirable to be able to generate a report pertaining to the particular equipment. In the white board system, customized reports cannot be generated automatically. Obtaining customized information takes a substantial investment of time to look through various charts on the white boards. Accordingly, there is a need for an automated equipment management and reservation system that generates customized report to assist the user in covering equipment.

### SUMMARY OF THE PREFERRED EMBODIMENTS

The present invention provides an automated equipment management and reservation system that overcomes the problems and disadvantages of the prior art. In a preferred embodiment of the invention, the equipment management system includes a reservation summary that displays the number of reservations that have been made for a specified date and the type of equipment to which each reservation pertains. The scope of the reservation summary can be altered in accordance with the interests of the user. Preferably, the system includes a site scope, a reservation scope and a selection scope. The site scope allows the user to view the reservation summary with respect to the entire marketing company or narrow the scope to a particular route, city, center or dealer. The reservation scope enables the user to view the reservation summary with respect to the status of reservations. For example, the user will be able to view the confirmed reservation, the tentative reservations or the canceled reservations. The confirmed and tentative reservation information will be useful to the user to determine the number of equipment that will be needed to fulfill each reservation. The canceled reservation information will be useful in spotting customer service problems. The route selection scope enables the user to view the equipment that is being rented for in-town use or one-way use.

Upon selection of the scope, the reservation summary displays the number of reservations that have been made for each specific date for each specific type of equipment, within the purview of the selected scope. For ease of reading, the reservation summary information is preferably provided in a chart format wherein the a list of equipment comprises one axis on the chart and a list of dates comprises the second axis on the chart. The reservation summary is updated regularly using a batch program that obtains information from the marketing company server. If the system is not receiving regular updates from the marketing company server, an update indicator flashes red to alert the user of a problem with the system. Early indication of a possible problem minimizes the risk of losing information in the equipment management system.

In addition to the broad overview presented in the summary reservation, the system preferably includes a detailed reservation screen that provides a list of equipment that has been reserved for a specific date. The detailed reservation screen preferably includes more specific information regarding each reservation such as the post date, the route, the dealer name, the reservation number, the origin of the reservation, the destination of the equipment, the type of equipment reserved, the coverage status, and the customer's identification information. To post a reservation, a post activation key is selected which enables the user to input the reservation information.

Upon posting a reservation, the equipment will need to be covered and scheduled. The detailed reservation screen preferably includes a notes window, for the entering and viewing of any notes pertaining to the scheduling of the equipment that would be useful to the dealers. The detailed reservation screen is preferably color-coded to show reservations that have been covered in white, reservations that have been partially covered in yellow, and reservations that have not been covered in red. The detailed reservation screen preferably includes a print function that enables the user to obtain a printed copy of the information in the detailed reservation screen.

Another feature of the automated equipment management and reservation system is the “equipment at site” feature. Wherein the detailed reservation screen provides the user with information pertaining to reservations made on a particular date, the equipment at site feature provides the user with information pertaining to the equipment available at a particular site. The equipment at site feature preferably includes information regarding the location, type of equipment available at the site, the number of equipment available at the site, and whether the equipment is designated for in-town or one-way use.

The equipment at site feature preferably includes search capability that allows the user to search other locations for equipment availability. If a particular location does not have sufficient equipment to cover the reservations, the search feature can be used to find other nearby locations having the equipment. Upon finding the equipment at a different location, the equipment is dispatched to the pick-up location. The system tracks the dispatch from one location and the receipt by the pick-up location and updates the inventory of both locations to reflect the shift in equipment.

In a preferred embodiment of the invention, the system updates automatically and regularly. The equipment at site feature preferably includes an update indicator that informs the user of the date and time on which the system was last updated. If there is a system failure, and the information is not updated regularly, the update indicator flashes to warn the user of an update problem.

The equipment management system preferably includes a detailed equipment inventory screen that provides a report of the inventory of a particular type of equipment at a given location. In the detailed equipment inventory field, the system lists all of the equipment of the type specified and the system lists the reservation status for each piece of equipment. Accordingly, the user will be able to view the status of each piece of equipment of a specified category at a particular location and determine whether any of the equipment is available for rental.

The automated equipment management and reservation system preferably enables the user to input specific information pertaining to a reservation, such as, the customer's identification information, equipment information, payment information, and any notes pertaining to the transaction. This information is accessible to all users of the equipment management system and facilitates the presentation of exceptional service to the customers.

Other objects, features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which

FIG. 1 is a reservation summary screen of a preferred embodiment of the present invention depicting the number of reservations for each specified equipment and for each specified date;

FIG. 2 is a detailed reservation screen of a preferred embodiment of the present invention depicting the equipment that has been reserved for a specified date;

FIG. 3 is an equipment at site feature of a preferred embodiment of the present invention, depicting a summary of the equipment and reservations at a particular site as it relates to a specific reservation;

FIG. 4 is a screen that depicts scheduled reservations of a preferred embodiment of the present invention;

FIG. 5 is a preferred embodiment of a customer reservation/transaction of the automated equipment management and reservation system of the present invention;

FIG. 6 is a preferred embodiment of the equipment information for a selected customer reservation/transaction of the automated equipment management and reservation system of the present invention;

FIG. 7 is a preferred embodiment of the payment information for the selected customer reservation/transaction of the automated equipment management and reservation system of the present invention;

FIG. 8 is a preferred embodiment of the notes for a selected customer reservation/transaction of the automated equipment management and reservation system of the present invention;

FIG. 9 is a preferred embodiment of the graphical interface of the find function of the automated equipment management and reservation system of the present invention;

FIG. 10 is a preferred embodiment of the graphical interface of the posted/not posted report of the automated equipment management and reservation system of the present invention;

FIG. 11 is a preferred embodiment of the graphical interface of the reserved equipment report of the automated equipment management and reservation system of the present invention;

FIG. 12 is a preferred embodiment of the graphical interface of the equipment at site feature of the automated equipment management and reservation system of the present invention;

FIG. 13 is a preferred embodiment of the graphical interface of the detailed equipment information screen of the automated equipment management and reservation system of the present invention;

FIG. 14 is a preferred embodiment of the graphical interface of the transfer function of the automated equipment management and reservation system of the present invention;

FIG. 15 is a preferred embodiment of the graphical interface of the equipment identification history feature of the automated equipment management and reservation system of the present invention;

FIG. 16 is a preferred embodiment of the graphical interface of the hookup information feature of the automated equipment management and reservation system of the present invention;

FIG. 17 is a preferred embodiment of the graphical interface of the route book of the automated equipment management and reservation system of the present invention; and

FIG. 18 is a preferred embodiment of the graphical interface of the confirmation scripts screen of the automated equipment management and reservation system of the present invention.

Like numerals refer to like parts throughout the several views of the drawings.

### DETAILED DESCRIPTION OF THE PREFERRED EMBODIMENTS

The present invention provides an automated equipment management and reservation system that includes access to tools, information, and aids for managing an equipment rental business. In a preferred embodiment of the invention, the system provides the user with reservation information in several different formats. The user is able to view reservations for an entire marketing company for a specific date, or with respect to a specific type of equipment. Additionally, the scope of the reservation information can be changed to display reservations for a particular location, or for specific equipment at that location.

In addition to displaying reservation information, the system tracks the equipment inventory at each location and automatically updates the inventory when equipment is dispatched to another location or received from another location. To facilitate communication between rental locations, the system provides a means for transmitting messages pertaining to specific reservations or specific equipment.

The automated equipment management and reservation system of the present invention is preferably available to users on a network. The network has at least one computer-server for communicating with users. Communication with the users is preferably carried out using a browser program on a computer-terminal at a location remote from the computer-server.

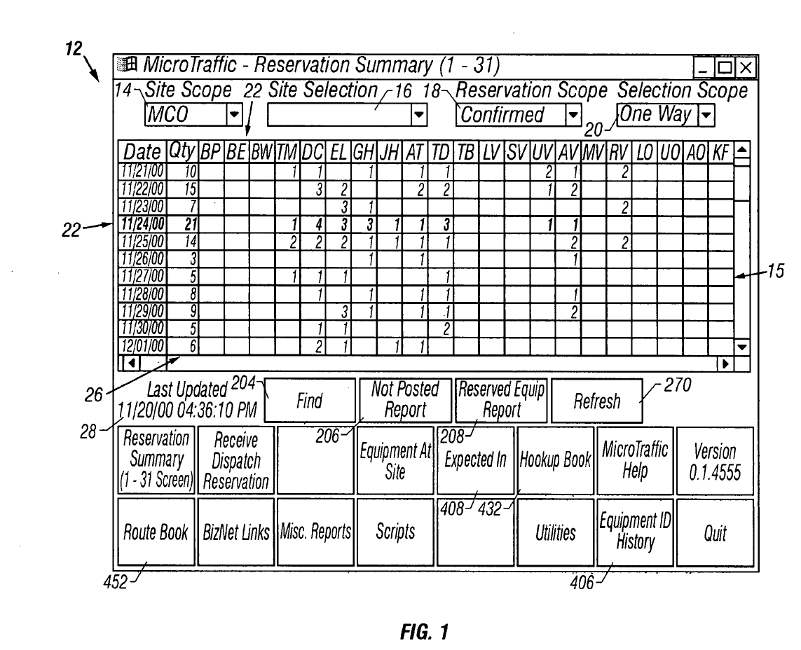

FIG. 1 depicts a user interface of the preferred embodiment of the automated equipment management and reservation system 10 having a reservation summary 12 which shows the number of reservations 15 that have been made for a specified date and the type of equipment to which each reservation pertains. To narrow the scope of the reservation summary 12, the system 10 preferably enables the user to select the scope of the information that is provided on the reservation summary 12. For example, the user may choose to view the reservations for all of the dealers in the area or the user may choose to focus on a particular dealer. Similarly, the user may wish to view only confirmed reservations. In a preferred embodiment, the automated equipment management and reservation system 10 allows the user to define the scope of the information provided by using a site scope 14, a site selection 16, a reservation scope 18 and a route selection scope 20, all of which preferably include a pull down menu that provides the user with the available choices for each site selection.

The site scope 14 allows the user to view the reservation summary 12 with respect to a particular location. For example, in one embodiment of the invention, the options provided for the site scope 14 could be the entire marketing company, or a specific route, city, center or dealer. Marketing company is used herein to refer the supervising entity of a cluster of dealerships or centers. If the user chooses to view the reservation summary 12 with respect to the broadest possible scope, the user can choose the marketing company, preferably from a drop down menu provided by the site scope 14.

Upon selecting the marketing company as the site scope, the reservation summary 12 will provide information for all centers or dealers within the purview of the marketing company. For a narrower scope, the user can choose to view the reservation summary 12 with respect to a specific route, city or dealer. If a route is selected for the site scope 14, the site selection 16 will provide the user, preferably by way of a drop down menu, with the routes that are available for selection. The user can then select an available route. Upon selecting a route, the reservation summary 12 will provide information regarding reservations pertaining to the specified route.

Similarly, the user can choose to view the reservation summary 12 with respect to a particular city. If a city is selected for the site scope 14, the site selection 16 will provide the user, preferably by way of a drop down menu, with the cities that are available for selection. The user can then select an available city. Upon selecting a particular city, the reservation summary 12 will provide information regarding reservations pertaining to the specified city.

Likewise, the user can choose to view the reservation summary 12 with respect to a particular dealer or reservation center. If the dealer is selected for the site scope 14, the site selection 16 will provide the user, preferably by way of a drop down menu, with the dealers that are available for selection. The user can then select an available dealer. Upon selecting a particular dealer, the reservation summary 12 will provide information regarding reservations pertaining to the specified dealer.

The reservation scope 18 of the equipment management system 10 allows the user to view the reservation summary 12 with respect to the status of reservations. In a preferred embodiment of the invention, the reservation scope 18 allows the user to view reservations pertaining to confirmed, tentative or canceled reservation. A confirmed reservation refers to a booking wherein the customer has indicated, with certainty, that he or she will need the equipment that is being reserved. In one embodiment of the invention, confirmed reservations refer to bookings for which the customer has paid a deposit. A tentative reservation refers to a booking wherein the customer has expressed an interest in renting the equipment but has not yet made a final decision as to the rental. By providing confirmed and tentative reservation information, the equipment management system 10 provides the user with the information that is needed to determine the number of equipment that will be needed to fulfill each reservation.

In a preferred embodiment of the invention, the system 10 also provides the user with information regarding canceled reservations. Canceled reservations are especially useful in investigating customer service issues. If desired, the user can follow-up with the customers who have canceled their reservations to determine if there were any problems with the customer service that they received that caused them to change their minds with respect to renting equipment.

In a preferred embodiment of the invention, the reservation scope also allows the user to view reservations for which the pick up date has passed. This information can be useful for a variety of reasons, including, evaluating customer service issues or keeping track of the location of the equipment.

The selection scope 20 allows the user to view equipment that is being rented for in-town use, one-way use or all equipment. In-town use, as used herein, refers to equipment that is rented from one rental location, used within the general geographical area of the rental location, and returned to the same rental location. One-way use refers to equipment that is rented from one rental location, moved to another geographical area and returned to a rental location different than the pick-up rental location.

Upon selection of the scope of the information to be viewed, the automated equipment management and reservation system 10 preferably displays the number of reservations that have been made for each specific date for each specific type of equipment. In particular, the equipment management system 10 preferably includes an equipment bar 22. The embodiment shown in FIG. 1 depicts two-letter abbreviations of various equipment, such as, BP, BE, BW, TM, DC, EL, etc. By way of example, equipment that is represented on the equipment bar includes trucks, pick-up trucks, vans, box vans, 10 foot, 12 foot, 17 foot, 24 foot, and 26 foot moving vans, auto transports, tow dollies, tow bars, various sized trailers, and support rental items such as dollies and furniture pads. This is not intended to be a comprehensive list of equipment. Additional equipment may be included as needed.

In a preferred embodiment of the invention, the reservation summary 12 is presented in a chart format wherein the equipment bar 22 comprises one axis on the chart and the date bar 24 comprises the second axis on the chart. The date bar 24 preferably lists upcoming dates in chronological order, for a specified duration of time. In one embodiment of the invention, the reservation summary 12 is provided for a 90 day period. The reservation summary preferably includes a quantity bar 26 that provides the total number of equipment that has been reserved for a particular day. Accordingly, by viewing the chart format of the reservation summary 12, as shown in FIG. 1, the user will be able to view the number of reservations for a specified piece of equipment for a specified day.

In the preferred embodiment of the invention, the reservation summary 12 includes an update indicator 28 that depicts the date and time for which the reservation summary 12 was last updated. The automated equipment management and reservation system 10 is preferably designed to automatically update the information regularly using a batch program that obtains information from the marketing company server. If the system 10 is not receiving regular updates from the marketing company server, the update indicator 28 provides an alarm. The alarm preferably includes a visual indication, such as a red font color, that the system 10 is not updating regularly. Early indication of a possible problem minimizes the risk of losing reservations in the equipment management system.

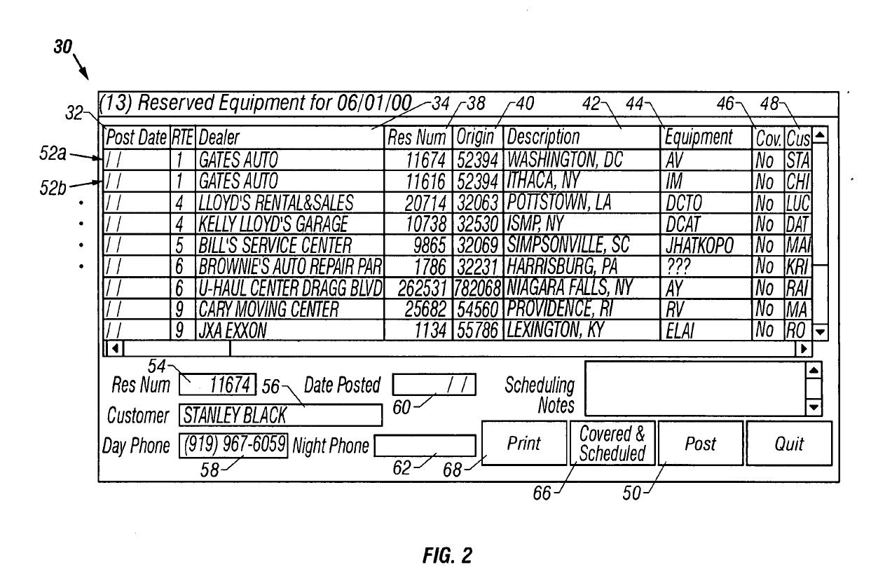

As shown in FIG. 2, the system 10 preferably includes a detailed reservation field 30 that provides a list of the equipment that has been reserved for a specific date. The reservation summary 12 and the detailed reservation screen 30 are preferably linked such that, by clicking on a specific date on the date bar 24 of the reservation summary 12 (shown in FIG. 1), the detailed reservation screen 30 is shown to the user. The detailed reservation screen 30 preferably includes information regarding the post date 32, the route 34, the dealer name 36, the reservation number 38, the origin of the reservation 40, the destination of the equipment 42, the type of equipment 44, the coverage status 46, and the customer's identification information 48.

The detailed reservation screen 30 includes a post activation key 50 that enables the user to post a new reservation. Reservations are preferably posted at least two days in advance of the date that the equipment is needed. To post a reservation, the post activation key 50 is selected and the information regarding the reservation is inputted. Reservation entry 52a provides an example of the type of information that could be inputted during the posting of a reservation. Reservation entry 52a indicates that the route 34 for the equipment is “1,” the dealer's name 36 is “GATES AUTO,” the reservation number 38 is “111674,” the origin of the reservation 40 is “52394” (which is the identification number of a particular dealer or reservation center), the destination of the equipment 42 is “WASHINGTON, DC,” the type of equipment 44 is “AV” (which refers to a particular size trailer), the “covered” status 46 is “NO” and the customer identification information is “STANLEY BLACK.”

In a preferred embodiment of the invention, when a reservation entry is highlighted, some of the reservation information is also provided on another portion of the detailed reservation screen 30. For example, in the embodiment shown in FIG. 2, when reservation entry 52a is highlighted, the reservation number “11674” is provided in a reservation number window 54, the customer's name “STANLEY BLACK” is provided in a customer window 56, the customer's day phone number is provided in the day phone window 58. Additionally the post date can be shown in the date posted window 60 and the evening phone number can be shown in the night phone window 62.

Once the reservation is posted, the equipment will need to be covered and scheduled. That is, the user must determine whether there is sufficient equipment at the selected dealer to fulfill the reservations for that dealer. In entry 52a, the coverage status 46 indicates that the reservation has not yet been covered. The scheduling and coverage process is discussed in detail below. If there are any special scheduling notes pertaining to the scheduling of the equipment that would be useful to the dealers, the notes can be entered and will appear in a scheduling notes window 64 of the detailed reservation screen 30. Upon completion of the covering and scheduling of equipment, the coverage status 46 can be changed to “YES” by activating the “Covered and Scheduled” key 66 in the detailed reservation screen 30. In one embodiment of the invention, the detailed reservation screen 30 is color coded such that, for example, reservations that are covered are shown in white, reservations that are partially covered are shown in yellow and reservations that are not covered are shown in red. The detailed reservation screen 30 preferably includes a print function 68 that enables the user to obtain a printed copy of the information on the detailed reservation screen 30.

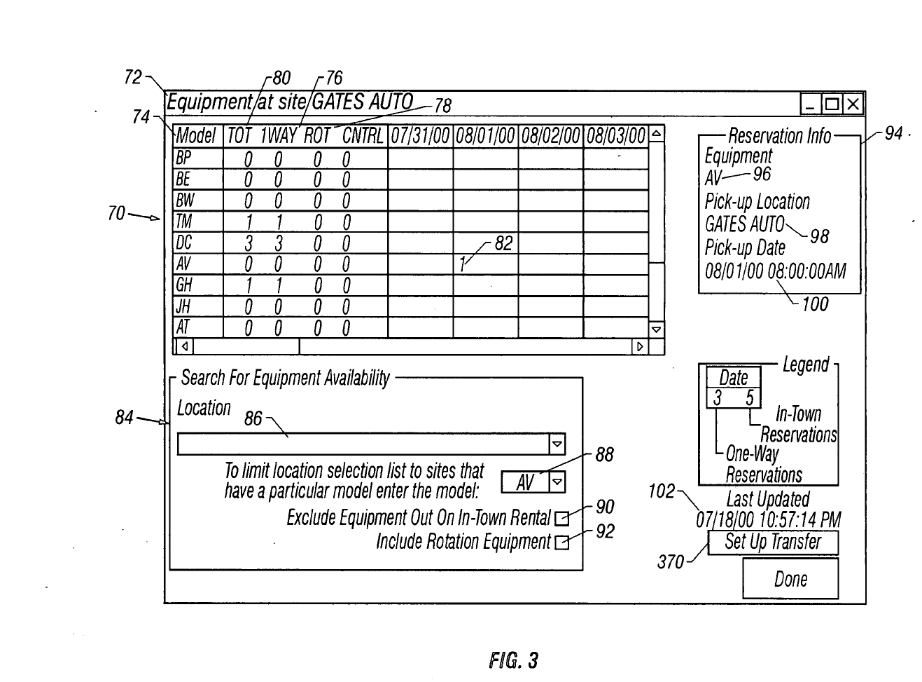

As shown in FIG. 3, the “equipment at site” field 70 of the automated equipment management and reservation system 10, provides the user with information pertaining to the equipment available at a particular site. The equipment at site feature 70 is preferably linked to the detailed reservation screen 30 (shown in FIG. 2). In a preferred embodiment of the invention, the equipment at site feature 70 can be accessed by highlighting a reservation entry 52 in the detailed reservation screen 30 (shown in FIG. 2) and pressing the F5 function key.

The equipment at site feature 70 preferably includes information regarding the location 72 for which the information is provided, the types of equipment available 74, the number of equipment that is designated for one-way use 76, the number of equipment that is designated for rotational (or in-town) use 78, and the total equipment available at the site 80. Furthermore, the equipment at site feature 70 preferably includes the number of reservations 82 that have been made for each type of equipment for each specified date. For example, in the embodiment of the invention shown in FIG. 3, the equipment at site feature 70 shows that the information provided pertains to the site of “GATES AUTO”. There is one reservation for an “AV” trailer for “Aug. 1, 2000.” However, the total equipment available at site 80 indicates that GATES AUTO does not have any AV trailers available, either for one-way use 76 or for in-town use 78.

If GATES AUTO did have the desired equipment available, the coverage process could be completed. However, as indicated in FIG. 3 and discussed above, GATES AUTO does not have the desired equipment. In this instance, it will be necessary to search for locations that do have an “AV” trailer available. The equipment at site feature includes a search feature 84 that allows the user to search other locations for equipment availability. The search feature 84 provides several search criteria for the user. The user can view the equipment availability at a particular location by specifying the location in the location window 86. For the user's convenience, a drop-down menu is provided with a list of locations from which the user can choose.

The user can limit the search to view only the locations that have the “AV” trailer available. The search can be limited by entering model “AV” in the model selection window 88. Once a particular model has been entered, the drop down menu excludes all locations that do not have the model available. Accordingly, the user is provided with all of the locations that have the “AV” trailer available.

The search feature 84 preferably allows the user to exclude equipment out on “in-town” rental by providing an exclusion checkbox 90. If the exclusion checkbox 90 is selected by the user, the system 10 will not include equipment that is out on “in-town” rentals in its search results. Furthermore, the search feature 84 preferably allows the user to include rotation equipment by providing an inclusion checkbox 92. If the inclusion checkbox 92 is selected by the user, the system 10 will include all rotation equipment in its search results.

For the user's convenience, the equipment at site feature 70 includes a reservation reminder 94 that provides the user with basic reservation information, preferably including, the type of equipment 96 that has been reserved, the pick-up location 98, and the pick-up date 100. In the embodiment shown in FIG. 3, the type of equipment reserved is “AV,” the pick-up location is GATES AUTO, and the pick-up date is “Aug. 1, 2000, 8:00 a.m.” By providing this information on the equipment at site feature 70, the user will not need to return to the detailed reservation screen 30 to review the information.

The equipment at site feature 70 preferably includes an update indicator 102 that informs the user of the date and time on which the system 10 was last updated. This feature ensures that the user is receiving current, updated information. If there is a system failure, and the information is not updated regularly, the update indicator 102 preferably informs the user by changing color. The equipment at site feature 70 also preferably includes a set-up transfer key 370 that enables the user to initiate the transfer of equipment or check the status of an existing transfer, as explained in more detail below.

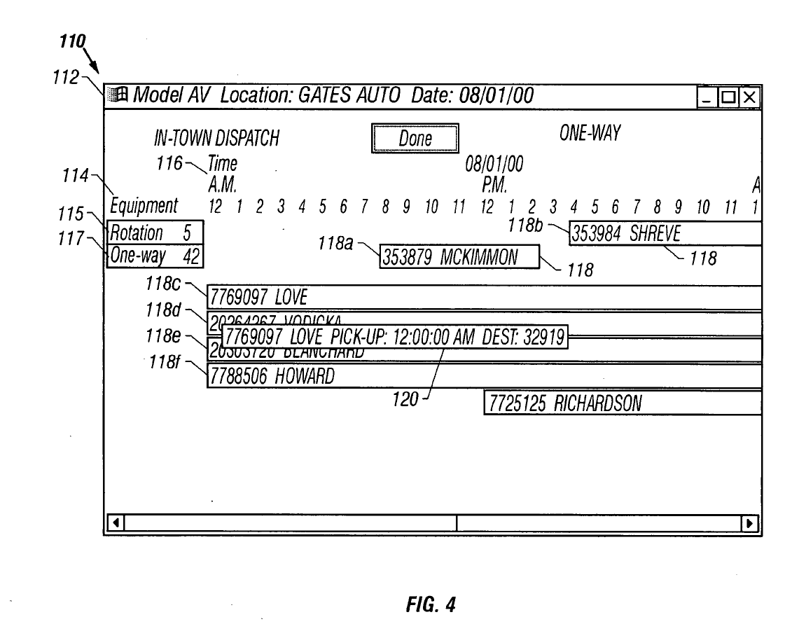

As shown in FIG. 4, in a preferred embodiment of the invention, the system includes a detailed display of reservations of the particular equipment of interest at a given location. The detailed reservation schedule 110 is linked to the equipment at site feature 70. Specifically, by clicking on a particular reservation 82 (shown in FIG. 3), the user is shown the detailed equipment inventory field. In the embodiment shown in FIG. 4, the detailed equipment inventory field includes a field identifier 112, an equipment inventory list 114, a time table 116, and a plurality of reservations, collectively referred to as 118 and individually referred to as 118a, 118b, etc.

The field identifier 112 preferably identifies the specific model, location, and date that correspond to the reservation 82 (shown in FIG. 3). In the embodiment shown in FIG. 4, the model of interest is “AV,” the location is GATES AUTO, and the date of reservation is “Aug. 1, 2000.” The equipment inventory list 114 identifies the number of “AV” trailers that are available at the specified location, and more preferably, the equipment inventory list 114, specifies the number of rotation “AV” trailers 115 at the location and the number of one-way “AV” trailers 117 at the location. The reservations 118 are aligned within the time table 116 in a manner that indicates the time period for which the equipment has been rented. For example, the rental period for reservation 118a begins at 8:00 a.m. The reservations 118 preferably include a reservation number and the last name of the customer. In a preferred embodiment of the invention, a pop-up window 120 provides additional information with respect to a particular reservation 118. For example, in the embodiment shown in FIG. 4, reservation 118c provides the reservation number and the last name of the customer. The pop-up window 120 provides additional information such as the scheduled time of pick-up and the destination of the “AV” trailer. The reservations are preferably color coded to distinguish between one-way reservations and in-town reservations. In the embodiment shown in FIG. 4, the shaded reservations indicate “in-town” reservations and the unshaded reservations indicate “one-way” reservations.

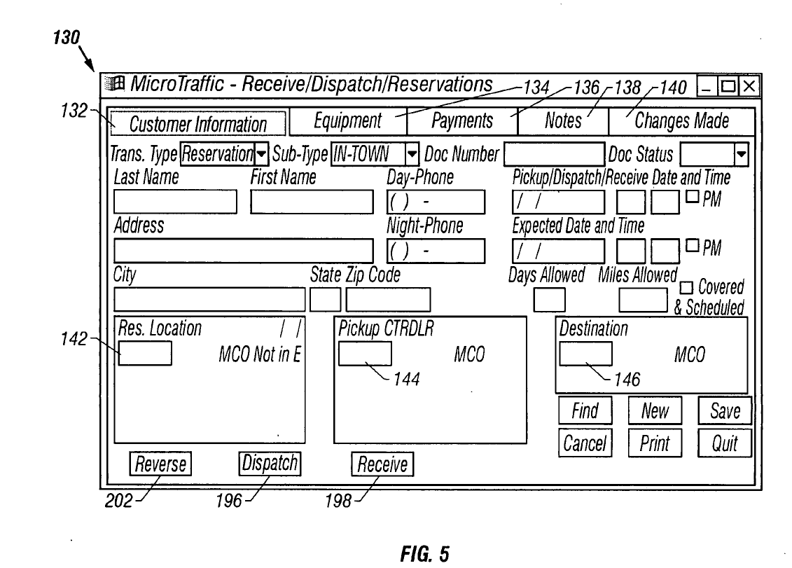

In a preferred embodiment of the invention, as shown in FIG. 5, the automated equipment management and reservation system 10 includes a customer reservation/transaction 130. One feature of the customer reservation/transaction 130 is that it enables the user to manually input reservation information. To enter a reservation, there are preferably five categories of information that will need to be inputted, including, customer information 132, equipment information 134, payment information 136, notes 138 and changes 140. In a preferred embodiment of the invention, each category has a separate folder and a separate graphical interface with the user.

FIG. 5 shows the graphical interface of the customer information 132. The customer information 132 preferably includes the name, address, day and night telephone numbers of the customer, the expected date of pick-up of the equipment, the reservation location, the pick-up center or dealer, and the destination of the equipment. In a preferred embodiment of the invention, if a question mark is entered in the reservation location window 142, the pick-up center window 144 or the destination window 146, the system 10 will provide the user with a menu of locations from which to choose.

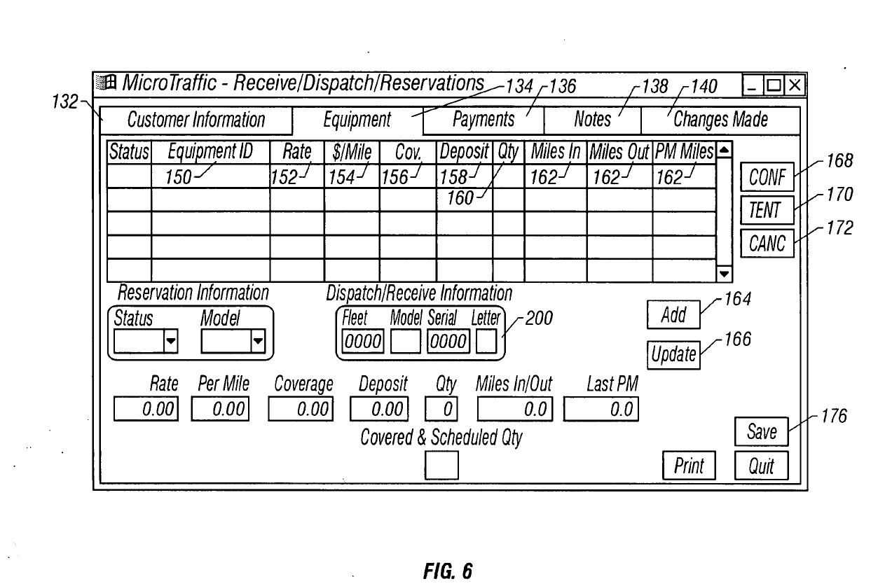

FIG. 6 shows a preferred embodiment of the graphical interface of the equipment information 134 of the system 10. The equipment information 134 preferably includes the equipment identification number 150, the rental rate of the equipment 152, the mileage charge for the equipment 154, the coverage status 156, the amount of deposit paid 158, the quantity of the equipment type 160 and the particular mileage indicators 162 of the equipment. To add the equipment information, the data is entered into the graphical interface and the add key 164 is activated. To modify the data, the revised information is entered into the desired field and the update key 166 is activated. Additional equipment may be added by providing the information pertaining to the additional equipment and activating the add key 164.

The status of each piece of equipment is specified as confirmed, tentative, or canceled. To facilitate the indication of the status of each equipment, confirmed key 168, tentative key 170 and canceled key 172 are provided on the equipment information 134. To indicate that the reservation with respect to a particular piece of equipment has been confirmed, at the time of entering the information regarding the equipment, the confirmed key 168 is activated. Similarly, the user can indicate that the reservation is tentative or canceled by activating the tentative key 170 and the canceled key 172, respectively. All additions, corrections and deletions can be saved by activating the save key 176.

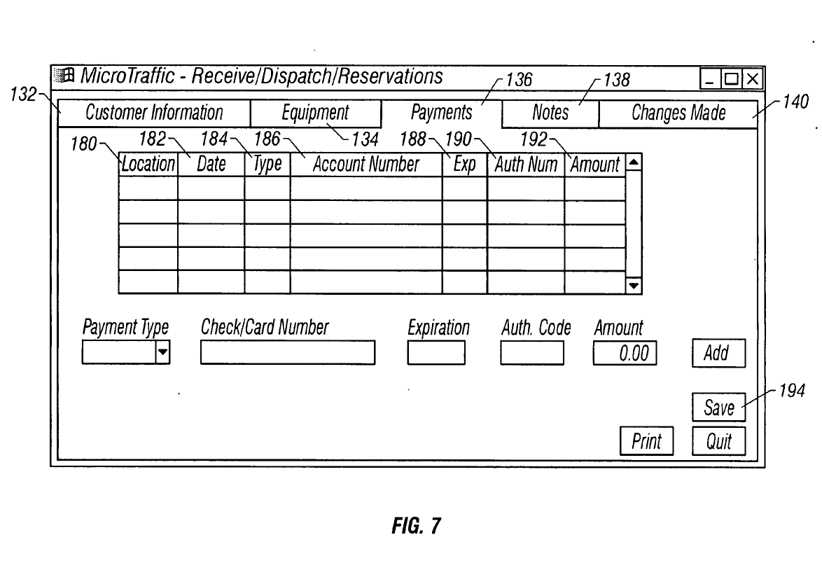

FIG. 7 shows a preferred embodiment of the graphical interface of the payment information 136 of the automated equipment management and reservation system 10. The payment information 136 allows the user to input, store and view information pertaining to the location 180, date of payment 182, type of payment 184, the account number 186 and expiration date 188 of a credit card, the authorization number 190, and the amount of payment 192. If more than one payment is made, the additional payments can be entered as well. The save key 194 can be utilized to save all modified or new information that is inputted.

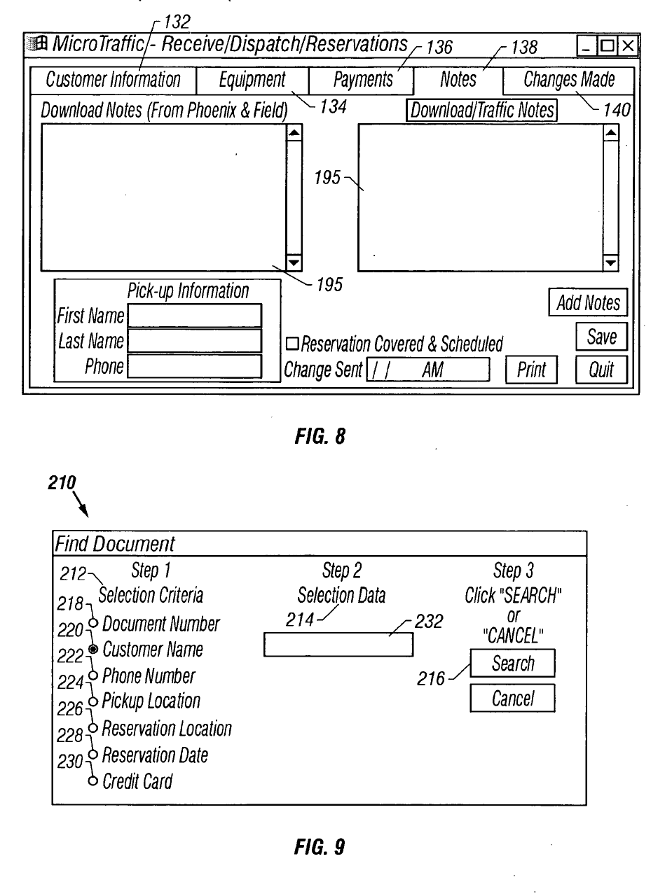

FIG. 8 shows a preferred embodiment of the graphical interface of the notes 138 of the automated equipment management and reservation system 10. The notes 138 enable the user to input, store and view messages pertaining to a specific transaction or customer. This feature is useful in communicating information to all users of the automated equipment management and reservation system 10 regarding the history of each reservation or transaction. In a typical reservation office, there can be 150 or more reservations taken in one day. The reservation takers are extremely busy. Often a reservation taker will handle a reservation that another reservation taker has already handled in a certain way. If the original reservation taker is unavailable or is busy with another customer, in the past, there was no way of knowing what had transpired with that reservation. The automated equipment management and reservation system 10 allows the original reservation taker to input and save information pertinent to the reservation. A subsequent reservation taker can simply look at the message section 195 of the notes 138 on the automated equipment management and reservation system 10 to view the history of the reservation of the transaction.

This feature is useful for sharing information with all users of the automated equipment management and reservation system, including users at the reservation center, pick-up location, dispatch location or any other location that uses the automated equipment management and reservation system. Some examples of the type of information that could be transmitted are changes in the pick-up date or time, changes in the equipment requested by the customer, change in the pick-up location of the equipment, or any special request or specific concern on behalf of the customer. All such information is maintained in the notes 138 and is available to for viewing by all users.

In reference to FIG. 5, the dispatch key 196 facilitates the dispatch of equipment from one location to another. To cover reservations for a particular equipment, the user of the automated equipment management and reservation system 10 checks the equipment inventory of the pick-up location. If the equipment that has been reserved by the customer is not available at the pick-up location, the equipment can be dispatched to the pick-up location from a nearby location. To dispatch equipment using the automated equipment management and reservation system 10, the user preferably activates the dispatch key 196. The user preferably enters the date, time, dispatching location, and the identification information of the equipment that is being dispatched. In a preferred embodiment of the invention, as shown in FIG. 6, the equipment identification, including the fleet number, model number, and serial number, is inputted in the dispatch/receive information window 200 of the equipment information 134 and saved.

The automated equipment management and reservation system 10 is configured to allow a user to indicate receipt of the dispatched equipment. In a preferred embodiment of the invention, as shown in FIG. 5, a receive key 198 is provided to initiate the “manual” receipt of equipment. Upon activating the receive key 198, the user is able to input the date, time, receiving location and the identification information for the equipment that has been received. In a preferred embodiment of the invention, as shown in FIG. 6, the equipment identification, including the fleet number, model number, and serial number, is inputted in the dispatch/receive information window 200 of the equipment information 134 and saved.

If the equipment is to be returned to the original dispatch location, the automated equipment management and reservation system 10 provides a reverse key 202, as shown in FIG. 5, to facilitate the return of the equipment to the original dispatch location. Upon activating the reverse key 202, an existing dispatch or receive is reversed. For instance, if it is desired to reverse a receive transaction, the receive information is automatically converted to the dispatched information, indicating that the equipment is no longer received.

As shown in FIG. 9, a find function 210 enables the user to search the automated equipment management and reservation system 10 using selected criteria. In a preferred embodiment of the invention, the user will be prompted to choose a selection criteria 212, input the selection data 214, and activate the search key 216 to begin the search. The selection criteria 212 preferably include document number 218, a customer name 220, phone number 222, pick-up location 224, reservation location 226, reservation date 228, or credit card information 230. The user will be able to search for reservations using any of these criteria. For example, to search for a specific customer's reservations, the customer name 220 is selected from the list of selection criteria, the customer's name is entered in the selection data window 232, and the search key 216 is activated. The automated equipment management and reservation system 10 will return a list of reservations for the criteria entered in the selection data window 232.

In a preferred embodiment of the invention, if the selection criteria 212 is pick-up location 224 or reservation location 226, the selection data 214 provides a supplemental window 234 that allows the user to add a date to the selection criteria. For example, if a user selects reservation location 226, the user will be prompted to enter the particular location in the selection data window 232 and a date in the supplemental window 234. Upon activating the search key 216, the system 10 will return a list of reservations for the specified reservation location for the specified date. In a more preferred embodiment of the invention, the system 10 returns all reservations within three days prior and three days after the dated entered in the supplemental window 234. This feature assists the user who cannot remember the exact date of the reservation for which he is searching. In the event that it is desired to cancel the find feature, the system 10 preferably includes a cancel key 236 that, upon activation, will cause the system 10 to exit the find function 210.

The find function of the automated equipment management and reservation system 10 is a useful feature of the invention in that it enables a user to find a reservation speedily and conveniently. This is especially useful for users who are assisting customers and need to retrieve existing reservation information immediately. In a preferred embodiment of the invention, to further facilitate the search for information, a find key 204 is provided on the reservation summary 12, as shown in FIG. 1.

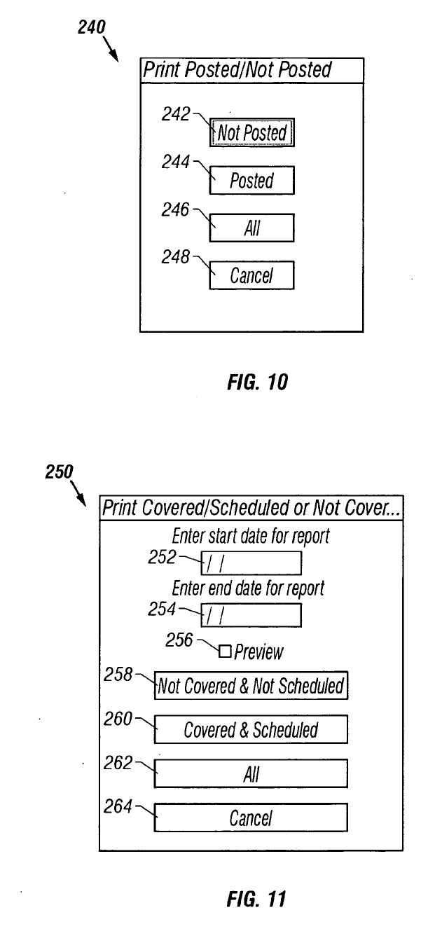

In a preferred embodiment of the invention, to enable the user to review the status of reservations or equipment, the automated equipment management and reservation system 10 generates a number of reports. In one embodiment of the invention, the system 10 generates a reservations report. In a preferred embodiment, as shown in FIG. 10, the user is able to specify the type of reservations to be included in the report. For example, in the embodiment shown in FIG. 10, the posted/not posted report 240 includes a “not posted” option 242, a posted option 244, an all option 246 and a cancel option 248. If the not posted option 242 is selected, the report will include all reservations that have not been posted. If the posted option 244 is selected, the report will include all reservations that have been posted. To generate a report that lists both posted and not posted reservations, the user can select the all option 246. The cancel option 248 will cancel and exit the posted/not posted report 240.

The posted/not posted report generated will preferably include the reservations for a specified number of days. In a more preferred embodiment of the invention, the range of days is preselected in the automated equipment management and reservation system such that the report will always list the reservations for the following two days, for example. The number of days for which the reservations are listed is preferably three days if the report is printed on a Friday. In a preferred embodiment of the invention, a user will be able to access the posted/not posted report 240 by activating the reservation report key 206 on the reservation summary 12, as shown in FIG. 1.

Another report that is preferably available to the user is the reserved equipment report 250, shown in FIG. 11. The reserved equipment report 250 preferably includes a start date window 252 and an end date window 254 the user can define the start date and the end date for the report by inputting the respective information in the start date window 252 and the end date window 254. The reserved equipment report 250 preferably includes a preview option 256 that, upon activation, allows the user to preview the report prior to printing it.

To further limit the scope of the reserved equipment report, the reserved equipment report 250 includes a “not covered and not scheduled” option 258, a “covered and scheduled” option 260, an all option 262, and a cancel option 264. If the not covered and not scheduled option 258 is selected, the report will include a list of reservations and equipment numbers that are not covered and not scheduled. If the covered and scheduled option 260 is selected, the report will include a list of reservations and equipment numbers that are both covered and scheduled for the dates selected. To generate a report that lists all reservations and equipment numbers that are within the date range selected, the user can select the all option 262. The cancel option 264 will cancel and exit the reserved equipment report 250. In a preferred embodiment of the invention, a user will be able to access the reserved equipment report 250 by activating the reserved equipment report key 208 on the reservation summary 12, as shown in FIG. 1.

To ensure that the user is provided with the most updated information, the reservation summary 12 preferably includes a refresh key 270, as shown in FIG. 1. Upon activation of the refresh key 270, the system 10 is updated to include all information that has been entered or modified. In a more preferred embodiment, the system 10 automatically refreshes at a set time interval. The reservation summary 12 preferably includes an update indicator 28 showing the date and time of the last update. If the system 10 is not receiving regular updates, the update indicator preferably warns the user, in the form of a visual alarm, that there is a problem with the automatic update feature.

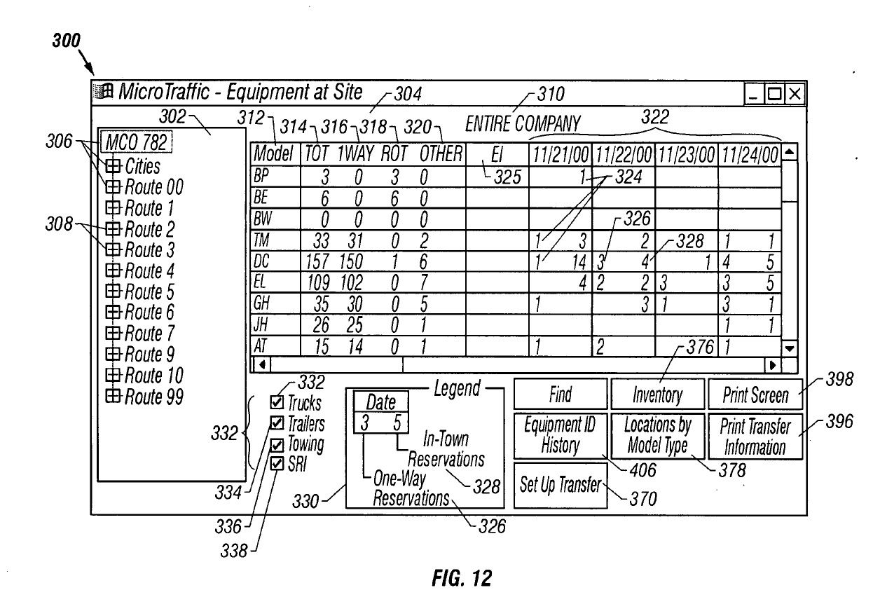

The automated equipment management and reservation system 10 preferably enables the user to view the location and the reservation status of all equipment. In a preferred embodiment of the invention, as shown in FIG. 12, the equipment at site feature 300 includes a scope field 302 and an equipment field 304. The scope field 302 enables the user to tailor the information provided in the equipment at site feature 300 to the user's area of interest. For example, in the embodiment shown in FIG. 12, the broadest scope available in the scope field 302 is the marketing company, designated as MCO 782. In a preferred embodiment of the invention, the various scopes 306 are provided in the form of expandable organization trees in the scope field 302. The equipment at site feature 300 can be tailored to show information pertaining to a particular city or a particular route. If the expansion symbol 308, designated as a “+” sign in FIG. 12, next to the cities scope is activated, the user will be provided with a list of all of the available cities from which to choose. Similarly, if the expansion symbol 308 next to the one of the route scopes is activated, the user will be provided with a list of all of the entities within the selected route.

Upon selection of a scope 306, the equipment information field 304 displays information pertaining to the equipment within the specified scope. For example, in the embodiment shown in FIG. 12, the selected scope is the entire marketing company. A scope identifier 310 provides a visual reminder of the selected scope 306. The equipment information field 304 preferably displays information using the following categories: model type 312, total 314, one-way 316, rotation 318, other 320, expected in 325 and by date 322. The model type 312 of the equipment preferably lists a two letter abbreviation for each piece of equipment. The one-way 316 refers to the number of equipment available for a one-way rental. The rotation 318 refers to the number of equipment available for in-town rental. The other 320 generally refers to equipment within the purview of the location of interest, which is not available for rental. The other 320 category would include, for example, equipment that is being tracked with a control number because it is in the repair shop for required repairs. Other 320 also refers to equipment that has been transferred out but has not yet been received or equipment that is for sale or on insurance hold. Total 314 refers to the sum of one-way 316, rotation 318 and other 320. The Expected in category 325 indicates the number of equipment that are expected to be received by the specified dealer for each type of equipment.

The equipment at site feature 300 preferably displays the reservation for each model by date 322. In the embodiment shown in FIG. 12, the reservation information 324 is shown in a table format, with the model type 312 defining the rows of the table and each date defining the columns of the table. The reservation information 324 is preferably presented in a two number format wherein the first number 326 refers to the number of one-way reservations and the second number 328 refers to the number of in-town reservations. The equipment at site feature 300 preferably includes a legend 330 to remind the viewer of the convention regarding the display of information, namely, that the first number 326 refers to the number of one-way reservations and the second number 328 refers to the number of in-town reservations.

The type of equipment that is listed in the equipment information field 304 can be tailored using the equipment type selector 332. For example, in the embodiment shown in FIG. 12, the user can choose to view trucks 334, trailers 336, towing equipment 338, support rental items 340, or any combination of these equipment. If all categories are selected, then all equipment will be displayed. To view selected equipment only, then the desired equipment is selected from the equipment type selector 332.

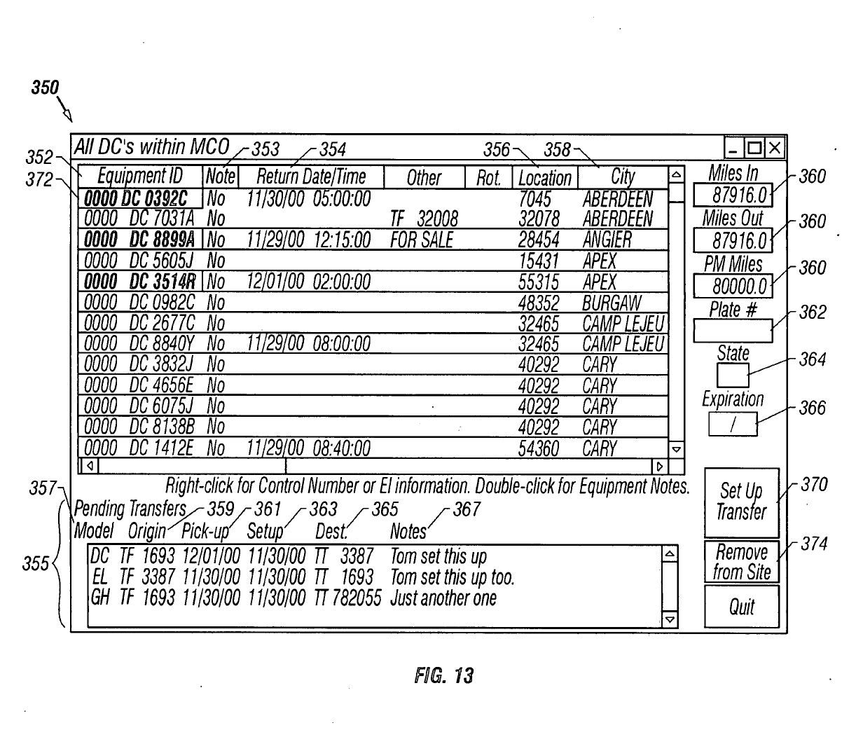

As shown in FIG. 13, the automated equipment management and reservation system 10 preferably includes a detailed equipment information screen 350 for each type of equipment that includes the equipment identification number 352, the return date and time 354, the location of the equipment 356, the city 358, the mileage information for the equipment 360, the license plate number 362, the state of registration 364 and the registration expiration date 366. The notes column 353 informs the user if there is a note for the specified equipment. The detailed equipment information screen 350 is preferably linked to the equipment at site feature 300 (FIG. 12) such that the user can click on a model type 312 in the equipment at site feature 300 to view the detailed equipment field 350.

In a preferred embodiment of the invention, the detailed equipment information screen 350 includes a set-up transfer key 370 that enables the user to initiate the transfer of equipment or check the status of an existing transfer. By highlighting an equipment entry 372 and activating the set-up transfer key 370, the system will provide the user with transfer information pertaining to the highlighted entry 372. The detailed equipment information screen 350 preferably includes a pending transfers section 355 that provides information pertaining to pending transfers, such as the model type 357 of the equipment being transferred, the equipment origin 359, the equipment pick-up date 361, the setup date 363, the equipment destination 365, and any notes 367 pertaining to the transfer.

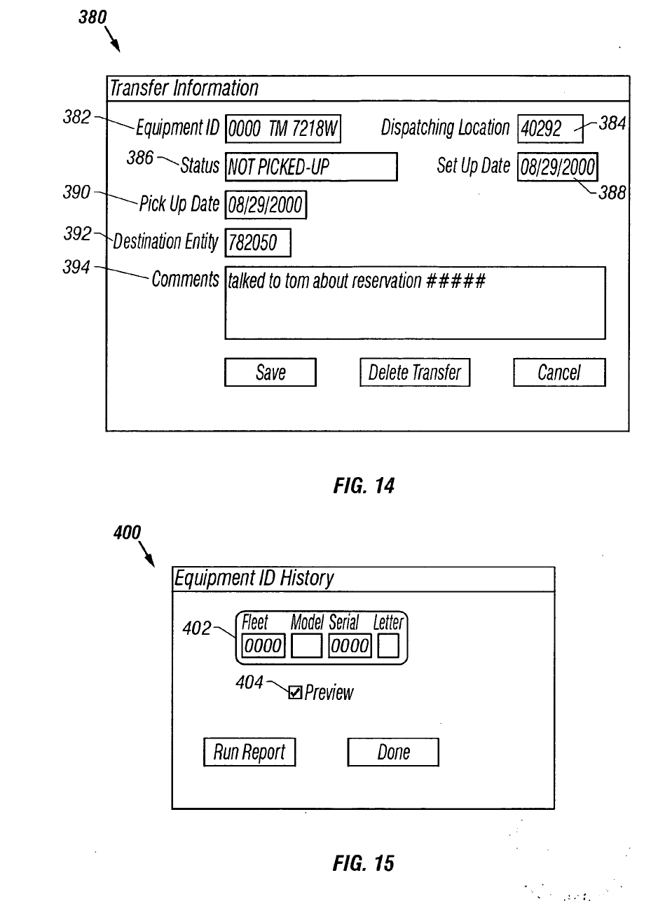

In a preferred embodiment, upon activation of the set-up transfer key 370, a transfer function 380 is displayed, as shown in FIG. 14. The transfer function 380 preferably includes the equipment identification 382, the dispatching location 384, the status of the transfer 386, the set-up date of the transfer 388, the pick-up date of the transfer 390, the destination entity 392 and a comments section 394. In the embodiment shown in FIG. 14, the status of the transfer 386 is “Not Picked Up” indicating that the transfer has been initiated but the equipment has not yet left the location. If the status of the transfer 386 was “Dispatched,” it would indicate that the equipment had been transferred out of the dispatching location 384 but had not yet been received at the destination entity 392. In the comments section 394, users can leave messages pertaining to a particular reservation or equipment. In reference to FIG. 13, if equipment that is listed on the detailed equipment information 350 does not exist, and is erroneously included in the list, the equipment can be deleted from the list by activating the “remove from the site” key 374. In a preferred embodiment of the invention, the “remove from the site” key 374 is activated only after investigation of the reason for the missing equipment.

In a preferred embodiment of the invention, as shown in FIG. 12, the user is able to generate a number of reports pertaining to the equipment inventory and location. In the embodiment shown in FIG. 12, the equipment at site feature 300 includes an inventory key 376, a “location by model type” key 378, the print transfer information key 396, and a print screen key 398. Upon activating the print screen key 398, the equipment management system 10 provides the user with a print out of the equipment at site feature 300. Upon activating the inventory key 376, the equipment management system 10 provides the user with a summary of the equipment model numbers, either for the entire marketing company or for an individual location, depending on the location that the user has selected. Activation of the “locations by model type” key 378 preferably results in a report that lists the specific model type sorted by equipment identification and equipment location. The “print transfer information” key 396 generates a report pertaining to transfers.

As shown in FIG. 15, the equipment management system 10 preferably includes an equipment identification history feature 400 that provides the user with information pertaining to a particular equipment. In a preferred embodiment, the user enters the equipment identification information 402 in the form of fleet, model, serial number and letter and in response, the system 10 provides the user with a report that lists the recent transactions that have occurred for that particular equipment. A preview feature 404 is available for previewing the information prior to generating the report. In a preferred embodiment, the equipment identification history feature 400 is linked to the equipment at site feature 300 (FIG. 12) and the summary reservation 12 (FIG. 1). The equipment identification history feature 400 can preferably be accessed by activating the equipment identification history key 406 in the equipment at site feature 300 (FIG. 12) or in the summary reservation (FIG. 1).

With reference to FIG. 1, the summary reservation preferably includes an “expected in” key 408, the activation of which generates a report that lists all equipment that is expected to be received within a marketing company. The report is preferably sortable by the date on which the equipment is expected to be received or the route through which the equipment will travel to arrive at its destination.

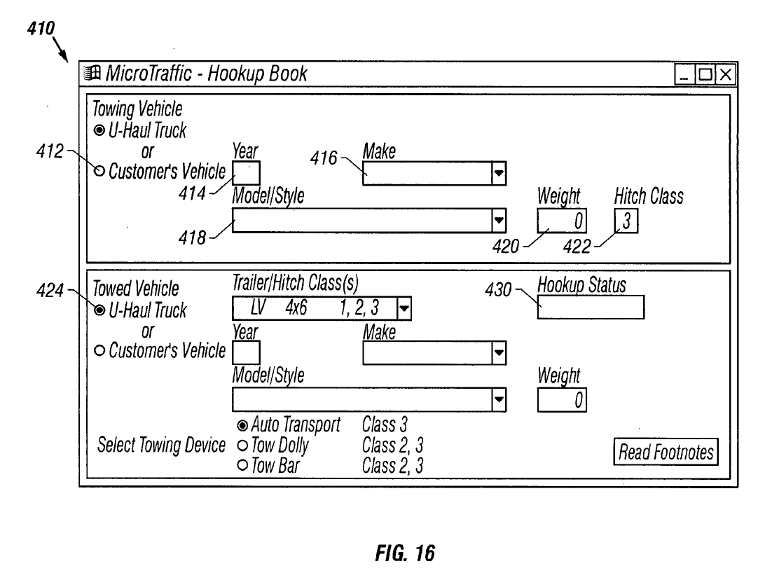

As shown in FIG. 16, in a preferred embodiment of the invention, the equipment management system 10 includes a hookup information feature 410. The hookup information feature 410 enables the user to verify the compatibility of a requested towing combination. For example, if a customer would like to use his own car to tow a rental trailer, the equipment management system can determine whether the towing combination is safe. To determine the safety of the towing combination, the user inputs information pertaining to the customer's vehicle 412, namely, the year 414, make 416, model 418, weight 420 and hitch class 422 of the customer's vehicle and information pertaining to the towed trailer 424. If the combination is safe, the hookup status 430 flashes green. If the combination is unsafe, the hookup status 430 flashes red. If there is insufficient information to determine the safety of the hookup, the hookup status 430 will be yellow and the equipment management system will preferably inform the user that additional information is need to determine the safety of the hookup.

The hookup information feature 400 can also determine the safety status of a hookup combination when the towing vehicle is a rental truck and the towed vehicle is the customer's vehicle. The hookup information feature 400 is preferably linked to the reservation summary 12 (FIG. 1) and is accessible from the reservation summary 12 by activating the hookup information key 432 in the reservation summary 12.

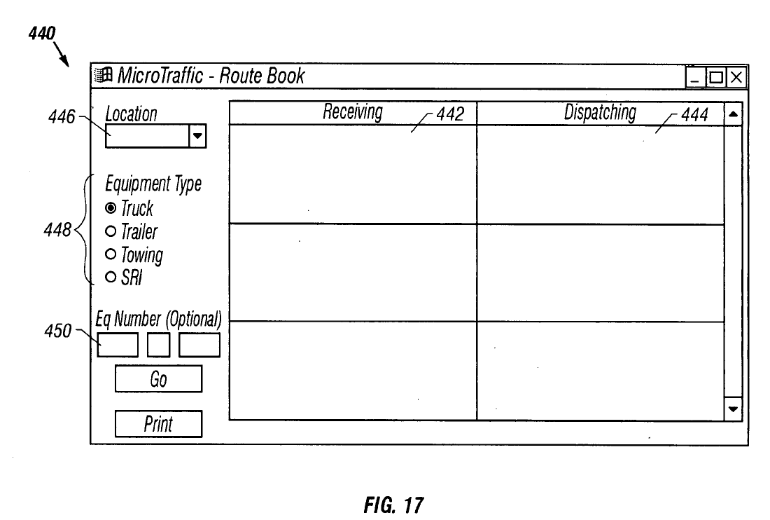

In a preferred embodiment of the present invention, as shown in FIG. 17, the equipment management system 10 includes a route book 440. The route book maintains the status of equipment at dealers that are not automated and report manually, hereinafter referred to as manual dealers. Any time that an “equipment receive” or “equipment dispatch” is entered for a manual dealer, the information will automatically be updated in the receiving area 442 and dispatching area 444, respectively, of the route book 440.

To view the receives and dispatches for a particular manual dealer, the dealer's location can be entered into the location area 446. To view the receives and dispatches for a particular type of equipment, a selection is made in the equipment type 448. If the user is interested in viewing the history of a particular equipment, the user can enter the equipment number in the equipment number window 450. The automated equipment management and reservation system 10 will preferably match up the equipment model numbers that have been received and dispatched, and list them next to each other in the receiving area 442 and the dispatching area 444, respectively. Dispatched equipment records are preferably deleted after a specified period of time, and more preferably, after 31 days. The route book 440 is preferably linked to the reservation summary 12 (FIG. 1) and is accessible from the reservation summary 12 by activating the route book key 452 in the reservation summary 12.

In a preferred embodiment of the invention, the automated equipment management and reservation system, provides information relating to the rental equipment business. For example, the system preferably includes a rate chart that provides the user with the rental rate for a particular piece of equipment based on the origin and destination locations. Other features that may be included are telephone numbers and addresses for rental locations and personnel; route assignment information and address information for entities within a marketing company; and, a list of rotation trucks available within the marketing company.

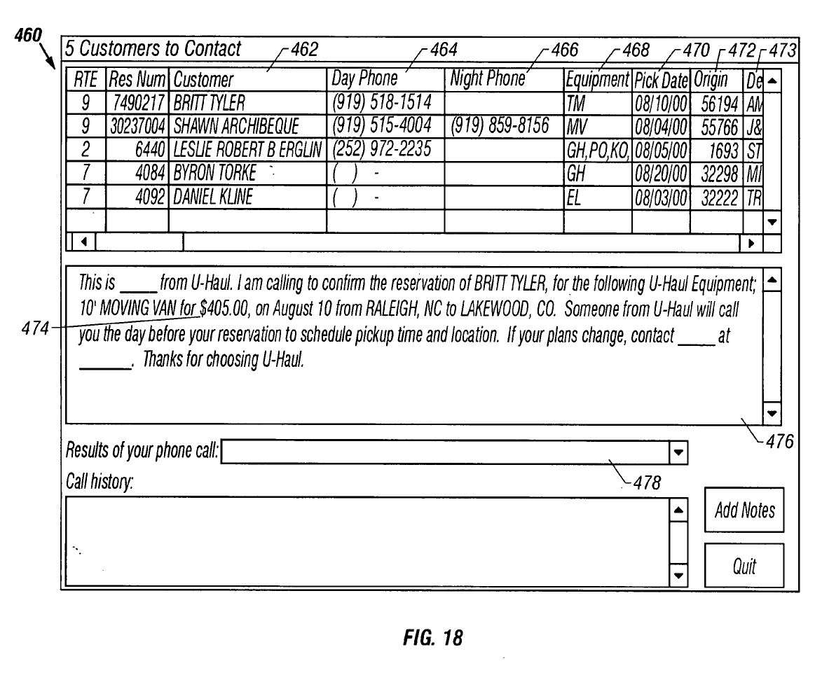

As shown in FIG. 18, the automated equipment management and reservation system 10 preferably includes a confirmation scripts screen 460 to facilitate the contact between a customer service representative and a rental customer. The confirmation scripts screen 460 preferably includes a list of customers 462 that need to called in order to confirm the reservation that the customer has made. The confirmation scripts screen 460 also provides the day and night phone numbers 464, 466 of the customer, the type of equipment 468 that the customer is renting, the pick-up date 470, the origin of the equipment 472, the destination of the equipment 473, and the rental rate 474. The confirmation scripts screen 460 also includes a script 476 to assist the customer service representative in confirming each detail of the reservation.

In a preferred embodiment of the present invention, the automated equipment management and reservation system 10 is configured to incorporate the details of the reservation into the script. For example, in the embodiment shown in FIG. 18, the highlighted entry is for BRITT TYLER. The script 476 includes the name of the customer (BRITT TYLER), the type of equipment that the customer is renting (10′ moving van), the rental rate ($405.00), the date of the reservation (August 10), the rental pick-up location (Raleigh, N.C.), and the destination (Lakewood, Colo.). By incorporating the reservation information directly into the script 476, the customer service representative will be able to confirm all of the details of the reservation in an efficient and professional manner. If desired, the customer service representative can record the result of the phone call in the results section 478 of the confirmation scripts screen 460.

The embodiments described above are exemplary embodiments of an automated equipment management and reservation system of the present invention. Those skilled in the art may now make numerous uses of, and departures from, the above-described embodiments without departing from the inventive concepts disclosed herein. For example, such departures could include alterations of the visual presentation of the graphical interfaces, the scope and extent of the information provided in each field, and the organization of the functional features of the invention to provide accessibility to the features from various fields of the invention. Accordingly, the present invention is to be defined solely by the scope of the following claims.

1. A method of rental equipment management for a plurality of rental locations on a network, the network having at least one computer-server for communicating with users, said method comprising the steps of:
displaying a reservation summary having reservation information pertaining to the type of equipment reserved and the date of reservation for a plurality of customer reservations; and
tracking the equipment inventory information for each rental location.

2. A method in accordance with claim 1 further comprising the step of customizing the scope of the reservation summary to display information pertaining to one of a particular rental location, city, route and dealer.

3. A method in accordance with claim 1 further comprising the step of customizing the scope of the reservation summary to display information pertaining to a particular type of reservation.

4. A method in accordance with claim 3 wherein the type of reservation is selected from one of confirmed, tentative and canceled reservations.

5. A method in accordance with claim 1 further comprising the step of customizing the scope of the reservation summary to display information pertaining to a particular route selection.

6. A method in accordance with claim 5 wherein the route selection is selected from one of one-way rental and in-town rental.

7. A method in accordance with claim 1 further comprising the step of updating the reservation information and the equipment information regularly.

8. A method in accordance with claim 7 further comprising the step of alerting the user upon the detection of an update failure.

9. A method in accordance with claim 1 wherein the equipment inventory information comprises the types of equipment available, the number of equipment designated for one-way use, the number of equipment designated for rotational use, and total equipment available.

10. A method in accordance with claim 1 comprising the step of searching the equipment inventory information to find a dispatching rental location having a particular piece of equipment.

11. A method in accordance with claim 10 comprising the step of dispatching the particular piece of equipment from the dispatching rental location to a receiving rental location, wherein the equipment inventory information is updated to reflect the dispatch of the equipment from the dispatching rental location to the receiving rental location.

12. A method in accordance with 11 wherein the receiving rental location receives the particular piece of equipment and wherein the equipment inventory information is updated to reflect the receipt of the equipment at the receiving rental location.

13. A method in accordance with claim 1 comprising the step of displaying customer information.

14. A method in accordance with claim 13 comprising the step of displaying payment information.

15. A method in accordance with claim 13 comprising the step of displaying notes that reflect the history of transacting with a customer.

16. A method in accordance with claim 1 comprising the step of verifying the compatibility of a requested towing combination, wherein the information pertaining to the towing vehicle and information pertaining to the towed vehicle are evaluated, and a determination is made as to the safety of the towing combination.

17. A method in accordance with claim 1 comprising the step of generating a script for confirmation of reservation, wherein the script comprises information pertaining to a particular reservation.

18. A method of rental equipment management for a plurality of rental locations, comprising the steps of:
displaying on a screen in communication with a computer a reservation summary having reservation information pertaining to the type of equipment reserved and the date of reservation for a plurality of customer reservations; and
tracking the equipment inventory information for each rental location.

19. A method in accordance with claim 18 further comprising the step of customizing the scope of the reservation summary to display information pertaining to one of a particular rental location, city, route and dealer.

20. A method in accordance with claim 18 further comprising the step of customizing the scope of the reservation summary to display information pertaining to a particular type of reservation.

21. A method in accordance with claim 20 wherein the type of reservation is selected from one of confirmed, tentative and canceled reservations.

22. A method in accordance with claim 18 further comprising the step of customizing the scope of the reservation summary to display information pertaining to a particular route selection.

23. A method in accordance with claim 22 wherein the route selection is selected from one of one-way rental and in-town rental.

24. A method in accordance with claim 18 further comprising the step of updating the reservation information and the equipment information regularly.

25. A method in accordance with claim 24 further comprising the step of alerting the user upon the detection of an update failure.

26. A method in accordance with claim 18 wherein the equipment inventory information comprises the types of equipment available, the number of equipment designated for one-way use, the number of eqiuipment designated for rotational use, and total equipment available.

27. A method in accordance with claim 18 comprising the step of searching the equipment inventory information to find a dispatching rental location having a particular piece of equipment.

28. A method in accordance with claim 27 comprising the step of dispatching the particular piece of equipment from the dispatching rental location to a receiving rental location, wherein the equipment inventory information is updated to reflect the dispatch of the equipment from the dispatching rental location to the receiving rental location.

29. A method in accordance with claim 28 wherein the receiving rental location receives the particular piece of equipment and wherein the equipment inventory information is updated to reflect the receipt of the equipment at the receiving rental location.

30. A method in accordance with claim 18 comprising the step of displaying customer information.

31. A method in accordance with claim 30 comprising the step of displaying payment information.

32. A method in accordance with claim 30 comprising the step of displaying notes that reflect the history of transacting with a customer.

33. A method in accordance with claim 18 comprising the step of verifying the compatibility of a requested towing combination, wherein the information pertaining to the towing vehicle and information pertaining to the towed vehicle are evaluated, and a determination is made as to the safety of the towing combination.

34. A method in accordance with claim 18 comprising the step of generating a script for confirmation of reservation, wherein the script comprises information pertaining to a particular reservation.

35. An equipment management system for tracking reservation information and equipment inventory information for a plurality of locations, comprising:
a reservation information field having information pertaining to the type of equipment reserved and the date of reservation; and
an equipment inventory field having information pertaining to the type of equipment and number of equipment available at each of the plurality of locations.

36. An equipment management system in accordance with claim 35, comprising a scope selector having at least one scope criteria, wherein upon the selection of one of the at least one scope criteria, the reservation field provides information pertaining to the selected scope criteria.

37. An equipment management system in accordance with claim 36, wherein the at least one scope criteria is selected from one of a particular rental location, city, route and dealer.

38. An equipment management system in accordance with claim 35, comprising an update indicator comprising the date and time of the last update of the system.

39. An equipment management system in accordance with claim 38, comprising an update indictor alarm that is activated if the system is not updating regularly.

40. An equipment management system in accordance with claim 35, wherein the equipment inventory field is searchable.

41. An equipment management system in accordance with claim 40, comprising a search field, wherein the search field includes a search request window, and upon activation of a search in the search field, the search field returns information pertaining to the search request.

42. An equipment management system in accordance with claim 41 wherein the search request includes a request for a location having a particular piece of equipment, and the search result includes an identification of the location having the particular equipment.

43. An equipment management system in accordance with claim 35 comprising an equipment dispatch field, the equipment dispatch field indicating the transfer of equipment from a dispatching location to a receiving location.

44. An equipment management system in accordance with claim 35 comprising a customer information field having identifying information for a customer.

45. An equipment management system in accordance with claim 35 comprising a payment information field having information regarding the type and amount of payment received from a customer.

46. An equipment management system in accordance with claim 44 comprising a notes field having information pertaining to the history of a transaction with the customer.

47. An equipment management system in accordance with claim 35 comprising a hook up information field, wherein the hook up information field receives information regarding a towing combination including a selected towing vehicle and a selected towed vehicle, provides a first signal when the towing combination is safe, and provides a second signal when the towing combination is unsafe.

48. An equipment management system in accordance with claim 35 comprising a script page, wherein the script page incorporates information pertaining to a particular reservation.
